(19) United States
(12) Patent Application Publication
(10) Pub. No.: US 2024/0364757 A1
(43) Pub. Date: Oct. 31, 2024

(54) DATA PROCESSING METHOD AND APPARATUS

(71) Applicant: SAMSUNG ELECTRONICS CO.,LTD., Suwon-si (KR)

(72) Inventors: Xusi WANG, Guangzhou (CN); Peisheng ZHENG, Guangzhou (CN); Weipeng Liao, Guangzhou (CN); Yuan YUAN, Guangzhou (CN); Yang LIU, Guangzhou (CN); Lianyu ZHAN, Guangzhou (CN)

(73) Assignee: SAMSUNG ELECTRONICS CO.,LTD., Suwon-si (KR)

(21) Appl. No.: 18/440,557

(22) Filed: Feb. 13, 2024

Related U.S. Application Data
(63) Continuation of application No. PCT/KR24/95054, filed on Jan. 26, 2024.

(30) Foreign Application Priority Data
Apr. 27, 2023 (CN) 202310473261.4

(51) Int. Cl. H04L 65/1094; H04L 65/1069; H04M 3/56

(52) U.S. Cl. CPC H04L 65/1094; H04L 65/1069; H04M 3/568

(57) ABSTRACT

There is provided a method and an apparatus performing the method. The method including displaying, on an interface of the first electronic device, identification information of at least one candidate electronic device, determining at least one second electronic device based on an operation of performed by the user of the identification information of the at least one candidate electronic device, acquiring audio recording data captured by the at least one second electronic device, and generating target audio data based on the acquired audio recording data, and providing the target audio data to a target application.

### CROSS REFERENCE TO RELATED APPLICATION

This application is a continuation of PCT/KR2024/095054, filed on Jan. 26, 2024, at the Korean Intellectual Property Receiving Office and claims priority under 35 U.S.C. § 119 to Chinese Patent Application No. CN202310473261.4 filed on Apr. 27, 2023, in the China National Intellectual Property Administration, the disclosures of each which are incorporated by reference herein in their entireties.

### BACKGROUND

### Field

The disclosure generally relates to an electronic apparatus and a method of operating the same. In particular, the disclosure relates to a data processing method and a data processing apparatus.

### Description of Related Art

With recent development and popularity of various smart devices, multi-device interconnection and interaction has become a trend. However, the multi-device linkage function needs to be further improved to provide users with a more convenient and richer experience.

### SUMMARY

One or more aspects of the disclosure provide a data processing method and apparatus that can offer a more convenient and richer multi-device linkage experience for users.

According to an aspect of the disclosure, there is provided a method performed by a first electronic device, the method including: displaying, on a display of a first electronic device, identification information of one or more candidate electronic devices; determining at least one second electronic device, from among the one or more candidate electronic devices, based on a selection by a user; acquiring audio data captured by the at least one second electronic device; generating target audio data based on the acquired audio data; and providing the target audio data to a target application.

The generating of the target audio data based on the acquired audio data may include: based on a number of the at least one second electronic device being one, using the audio data captured by the at least one second electronic device as the target audio data; based on the number of the at least one second electronic device being more than one, mixing first audio data captured by a first second electronic device and second audio data captured by a second second electronic device to obtain the target audio data, the acquired audio data including the first audio data and the second audio data; or mixing the audio data captured by the at least one second electronic device and third audio data captured by the first electronic device to obtain the target audio data.

The providing of the target audio data to the target application may include: transmitting the target audio data to a data transferring hardware abstraction layer of the first electronic device; and controlling the target application to read the target audio data from the data transferring hardware abstraction layer.

After determining the at least one second electronic device, the method may further include sending audio playback data of the target application to the at least one second electronic device, and controlling an audio playback apparatus of the at least one second electronic device to play the audio playback data.

The sending of the audio playback data of the target application to the at least one second electronic device may include: controlling the target application to transmit the audio playback data to a data transferring hardware abstraction layer of the first electronic device; reading the audio playback data from the data transferring hardware abstraction layer; and sending the read audio playback data to the at least one second electronic device.

The method may further include transmitting the read audio playback data to an audio hardware abstraction layer of the first electronic device to play the audio playback data through an audio playback apparatus of the first electronic device.

After providing the target audio data to the target application, the data processing method may further include: sending the target audio data external to the first electronic device via the target application, or saving the target audio data in the first electronic device via the target application.

The method may further include establishing a communication connection with the at least one second electronic device, or establishing a communication connection with the one or more candidate electronic devices, and wherein the acquiring of the audio data captured by the at least one second electronic device includes: acquiring, via the communication connection, the audio data captured by the at least one second electronic device.

According to another aspect of the disclosure, there is provided an apparatus including: a memory configured to store instructions, and at least one processor configured to execute the instructions to: display, on a display of a first electronic device, identification information of one or more candidate electronic devices; determine at least one second electronic device, from among the one or more candidate electronic devices, based on a selection by a user; acquire audio data captured by the at least one second electronic device; generate target audio data based on the acquired audio data; and provide the target audio data to a target application.

According to another aspect of the disclosure, there is provided a computer readable storage medium having a computer program stored thereon, wherein the computer program, when executed by a processor, implements a data method including: displaying, on a display of a first electronic device, identification information of one or more candidate electronic devices; determining at least one second electronic device, from among the one or more candidate electronic devices, based on a selection by a user; acquiring audio data captured by the at least one second electronic device; generating target audio data based on the acquired audio data; and providing the target audio data to a target application.

According to another aspect of the disclosure, there is provided an electronic device including: a memory configured to store instructions, and at least one processor configured to execute the instructions to: display a list including one or more candidate electronic devices; determine at least one second electronic device, from among the one or more candidate electronic devices, based on a selection by a user; establish communication with the at least one second electronic device; acquire data obtained by a component of the at least one second electronic device; generate target data based on the acquired data; and output the target data.

Additional aspects and/or advantages of the general idea of the disclosure will be described in part in the description that follows, and a further portion will be clear from the description or may be known from the implementation of the general idea of the disclosure.

### BRIEF DESCRIPTION OF THE DRAWINGS

The foregoing and other objects and features of exemplary embodiments of the disclosure will become clearer by the following description in connection with the accompanying drawings illustrating the exemplary embodiments, wherein:

FIG. 1 illustrates a method of operating a first electronic device according to an exemplary embodiment of the disclosure;

FIG. 2 illustrates is an example of an interface displaying identification information of at least one other electronic device according to an exemplary embodiment of the disclosure;

FIG. 3 illustrates a flowchart of a method for providing target audio data to a target application according to an exemplary embodiment of the disclosure;

FIG. 4 illustrates an audio processing architecture diagram in which a first electronic device normally uses its own audio capability according to an exemplary embodiment of the disclosure;

FIG. 5 illustrates an audio processing architecture diagram in which a first electronic device uses an audio capability of one other device according to an exemplary embodiment of the disclosure;

FIG. 6 illustrates an audio processing architecture diagram in which a first electronic device uses audio capabilities of multiple devices according to an exemplary embodiment of the disclosure;

FIG. 7 illustrates a flowchart of a method for sending audio playback data of a target application to at least one second electronic device according to an exemplary embodiment of the disclosure;

FIG. 8 illustrates an audio processing architecture diagram after a first electronic device ends use of an audio capability of at least one other device according to an exemplary embodiment of the disclosure;

FIG. 9 illustrates a block diagram of a structure of a data processing apparatus according to an exemplary embodiment of the disclosure.

### DETAILED DESCRIPTION

Reference will now be made in detail to embodiments of the disclosure, examples of the embodiments being shown in the accompanying drawings, wherein the same labels always refer to the same components. The embodiments will be illustrated below by reference to the accompanying drawings for the purpose of explaining the disclosure. The embodiments are not meant to be limited, but it is intended that various modifications, equivalents, and alternatives are also covered within the scope of the claims.

It should be noted that the terms “first”, “second”, etc. in the specification and claims of the disclosure and in the accompanying drawings above are used to distinguish similar objects and need not be used to describe a particular order or sequence. It should be understood that the data so used may be interchangeable if appropriate, so that the embodiments of the disclosure described herein may be implemented in an order other than those illustrated or described herein. The implementations described in the following exemplary embodiments are not intended to represent all embodiments consistent with the disclosure. Rather, they are only examples of devices and methods that are consistent with some aspects of the disclosure, as detailed in the appended claims.

It is noted herein that “at least one of several items” as it appears in the disclosure means including three parallel cases of “any one of the several items”, “a combination of any number of the several items”, and “all of the several items”. For example, “including at least one of A and B” includes the following three parallel cases: (1) including A; (2) including B; (3) including A and B. For another example, “performing at least one of operations one and two” means the following three parallel cases: (1) performing operation one; (2) performing operation two; (3) performing operation one and operation two.

The singular forms “a,” “an,” and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical and scientific terms used herein have the same meaning as those commonly understood by one of ordinary skill in the art to which the disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

According to an aspect of the disclosure, an electronic device may be used in various scenarios. In order to help with the reader understand the novel aspects of the disclosure, two scenarios (e.g., scenario 1 and scenario 2) in which the electronic device may be uses is described as follows:

Scenario 1: On a weekend, a first person (e.g., a father) is preparing a document that needs to be reported on the following Monday with a first electronic device (e.g., a tablet computer), while a second person (e.g., a child) related to the first person is reading a book (e.g., children picture book) with a second electronic device (e.g., a phone) of the first person. At this point, the phone receives a voice call from a colleague of the first person, and the second person has to be interrupted from reading the book and has to wait for the voice call from the first person to be completed. In this scenario 1, the first electronic device is unable to take advantage of an audio hardware capability of another electronic device, and as such, the second person is interrupted from conducting an activity performed on the second electronic device of the first user.

Scenario 2: A company holds a multi-person temporary meeting, and due to content requirements of the meeting, a meeting participant A conducts business discussions with a meeting participant B who is not present in person at the meeting via a voice call. Since a volume of sound output by a phone may be low, other meeting participants who are present in person at the meeting would have to move closer to the phone to clearly hear the content spoken by participant B. Moreover, when another meeting participant (e.g., participant C) speaks, in order to avoid the problem of limited range of phone microphone pickup, the phone needs to be passed to the speaker (participant C) to ensure that the meeting participant B can clearly hear the speech content. As such, it is often necessary to pass the electronic devices between multiple people in order to achieve better pickup effect. Furthermore, if a group call is temporarily built for multi-person voice group chat discussion, the current discussion has to be ended before restarting a group call, which is very inconvenient and time-consuming. Accordingly, for multi-person meetings or dinners and other scenarios, when communicating by voice via an electronic device, relying only on the speaker and microphone that come with the electronic device cannot meet the need for multiple people to conduct external communication simultaneously.

One or more aspects of the disclosure take into account the problems of the related art and provides an electronic device, a method and a system in which a feature (e.g., an audio feature) of a first device may be transferred to a second device. For example, a device (hereinafter, also referred to as a first electronic device) may use an audio capability of at least one client device (hereinafter, also referred to as a second electronic device) based on a selection of the at least one client device by a user. The host device may use an audio capture capability of each of the at least one client device (e.g., pick up audio through a microphone of each of the at least one client device), and/or may transfer audio playback data (e.g., VOIP call data) from the host device to at least one client device. For example, the host device may control an audio component, such as a microphone or a speaker, of the client device. Moreover, when the transferring ends, the host device may resume the user its own audio capability (e.g., a microphone or a speaker of the host device). This enables the use of the audio capabilities of other devices, which can enhance the audio experience in scenarios such as multi-person meetings and multi-person gatherings. However, the disclosure is not limited to audio capabilities, and as such, according to another embodiment, the host device may be able to transfer and control other capabilities or features of a client device. For example, the host device may control an video component, such as a display of the client device.

According to an embodiment of the disclosure, in scenario 1, the phone can transfer the voice call to the tablet computer, i.e., to use the audio capture capability and the audio playback capability of the tablet computer, so that the first person (e.g., the father) communicates with the colleague via voice through the tablet computer, and the second person (e.g., the child) continues to read the children picture book. According to an embodiment of the disclosure, in scenario 2, the phone of the meeting participant A can use the audio capture capabilities and the audio playback capabilities of the phones of other meeting participants who are present, so that the other meeting participants who are present in person can access the speech content of the meeting participant B who is not present in person through their own phones, and can communicate with the meeting participant B through their own cell phone.

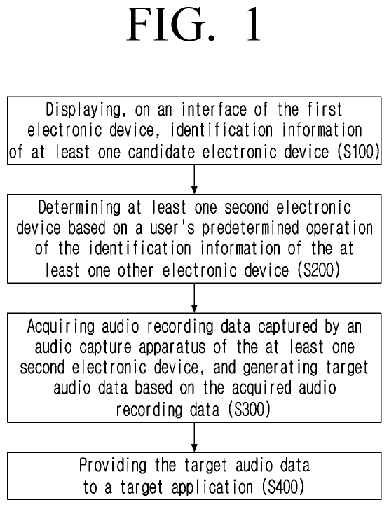

FIG. 1 illustrates a method of operating a first electronic device according to an exemplary embodiment of the disclosure. According to an embodiment, the method may be data processing method implemented by a computer program. For example, the data processing method may be performed by an application (e.g., a transferring application) installed in the first electronic device, or by a functional program implemented in an operating system of the first electronic device. As an example, the first electronic device may be a mobile communication terminal (e.g., a smartphone), a smart wearable device (e.g., a smartwatch), a tablet computer, a laptop computer, a game console, a digital multimedia player, and other electronic devices. The transferring application may be an APP of a service provider.

Referring to FIG. 1, in operation S100, the method may include displaying identification information of one or more candidate electronic devices. For example, the first electronic device may display identification information of the one or more candidate electronic devices on an interface of the first electronic device. The one or more candidate electronic devices may be referred to as one or more second electronic devices.

As an example, the one or more candidate electronic devices may include, but is not limited to, a nearby electronic device that may be searched by the first electronic device, and/or an electronic device that has a relationship with the first electronic device. For example, the one or more candidate electronic devices may be an electronic device that shares a same user account with the first electronic device). However, the disclosure is not limited thereto, and as such, the one or more candidate electronic devices be identified according to various other criteria.

As an example, the identification information of the at least one other electronic device may be displayed on the interface of the first electronic device based on a condition being met. For example, the condition may be a predetermined condition.

As an example, the predetermined condition may include, but is not limited to, at least one of: detecting a trigger operation of a user, receiving a VoIP call, initiating a VoIP call, entering a VOIP call state.

In operation S200, the method may include determining at least one second electronic device based on an operation related to the at least one candidate electronic device (S200). For example, the at least one second electronic device may be determined based on an operation performed by a user on the identification information of the at least one candidate electronic device. For example, the user may select one of the at least one candidate electronic device as a second electronic device.

As an example, the data processing method applied to the first electronic device according to the exemplary embodiment of the disclosure may further include establishing a communication connection with the at least one second electronic device, or establishing a communication connection with the at least one candidate electronic device.

According to an embodiment, the communication connection may be established with only the determined at least one second electronic device after operation S200. According to another embodiment, the communication connection may be established with all of the at least one other electronic device before operation S200. For example, the communication connection is established in advance with all of the candidate electronic devices.

As an example, the type of the communication connection may include a wired communication connection and/or a wireless communication connection. As an example, the type of the wireless communication connection may include, but is not limited to, at least one of WIFI direct, Bluetooth Low Energy (BLE), or Bluetooth (BT).

As an example, the second electronic device may be a mobile communication terminal (e.g., a smartphone), a smart wearable device (e.g., a smartwatch), a tablet computer, a laptop computer, a game console, a digital multimedia player, and other electronic devices. In an example case in which the number of second electronic devices is multiple (e.g., a plurality of second electronic devices are provided), the types of different second electronic devices may be the same or different, for example, a portion of the second electronic devices may be mobile communication terminals and another portion of the second electronic devices may be tablet computers.

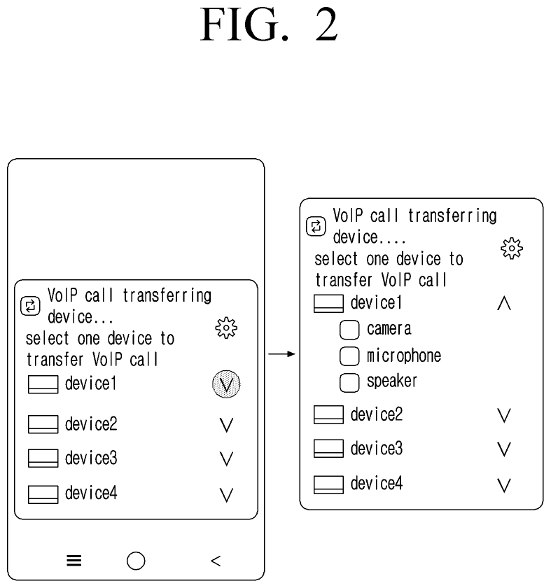

FIG. 2 illustrates an example of an interface displaying identification information of at least one candidate electronic device according to an exemplary embodiment of the disclosure. As an example, the operation performed by the user may include an operation of selecting to use an audio capture capability of any one of the candidate electronic devices (e.g., device1, device2, device3 or device4) and/or an operation of selecting to use an audio playback capability of any one of the candidate electronic devices. However, the disclosure is not limited to a selection of the second electronic device based on an user operation. As such, according to another embodiment, the second electronic device may be selected based on a particular criterion. For example, the second electronic device may be automatically selected based on a preset criterion.

In operation S300, the method may include acquiring audio data from the at least one second electronic device and generating target audio data based on the acquired audio data. For example, the audio data may be audio recording data captured by an audio capture apparatus (or an audio capture component) of the at least one second electronic device, and target audio data is generated based on the captured audio recording data.

As an example, the audio capture apparatus may include, but is not limited to, a microphone. In an example case in which the audio capture apparatus is a microphone, the audio recording data is microphone recording data.

As an example, the audio recording data captured by the audio capture apparatus of the at least one second electronic device may be acquired via the communication connection.

As an example, the operation of generating the target audio data may be based on a number of second electronic devices used for capturing the acquired audio recording data. In an example case in which the number of the at least one second electronic device is one, the audio recording data captured by the audio capture apparatus of the one second electronic device is used to generate the target audio data. In this case, the audio recording data captured by the audio capture apparatus of the one second electronic device may be used as the target audio data. In an example case in which the number of the at least one second electronic device is multiple (e.g., more than one), the method may include mixing the audio recording data captured by the audio capture apparatuses of the multiple second electronic devices to obtain the target audio data.

As another example, the operation of generating the target audio data based on the acquired audio recording data may include mixing audio recording data captured by the audio capture apparatuses of the at least one second electronic device and the first electronic device to obtain the target audio data.

In operation S400, the method may include outputting the target audio data. For example, the target audio data may be provided to a target application.

As an example, the number of target applications may be one or more. As an example, the type of the target application may include, but is not limited to, a VOIP APP (e.g., an application capable of making VOIP calls such as WeChat, QQ, etc.). In addition, other types of applications may be included, e.g., live streaming applications, etc. Moreover, although FIG. 1 illustrates a method related to audio data, the disclosure is not limited thereto, and as such, according to another embodiment, the method may be applied to other types of data. For example, the data acquired from the second device may be video data or other types of data captured or acquired by an input device of the second device. The input device may include, but is not limited to, a microphone, a camera, a sensor, etc.

As an example, the target application may be determined based on an operation of the user specifying the target application. In addition, as an example, an application that is about to make a VoIP call or is making a VOIP call may be automatically determined as the target application.

According to an embodiment, the method may further include sending the target audio data external to the first electronic device (e.g., outwardly) via the target application, and/or, saving the target audio data in the first electronic device via the target application.

As an example, the target audio data may be sent outwardly (e.g., external to the first electronic device) via the target application. In an example case in which the target application is a VOIP APP, the target audio data may be sent to a peer electronic device that is making a VoIP call with the first electronic device. In addition, as another example, the target audio data may be stored locally via the target application.

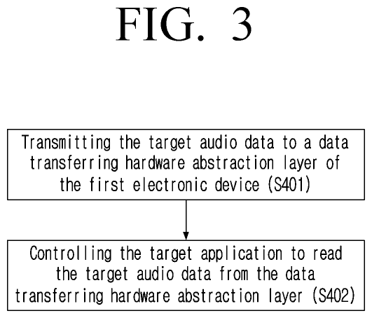

An exemplary embodiment of operation S400 will also be described below in connection with FIG. 3.

In addition, the data processing method applied to the first electronic device according to the exemplary embodiment of the disclosure may further include sending audio playback data of the target application to the at least one second electronic device and triggering an audio playback apparatus of the at least one second electronic device to play the audio playback data.

As an example, the audio playback apparatus may include, but is not limited to, a microphone, a speaker and/or a headset including a speaker and a headset.

In an example case in which the target application is a Voice over Internet Protocol application (VOIP APP), the audio playback data of the target application may be VoIP call data received by the target application that is sent by a VoIP call counterpart in real time, and VoIP call data sent to the VoIP call counterpart by the target application in real time is the target audio data, thereby enabling a user who is using the second electronic device to conveniently interact with a user of the VOIP call counterpart by voice. In addition, it is also possible for the user using the second electronic device and a user using the first electronic device to conveniently interact with the user of the VoIP call counterpart together.

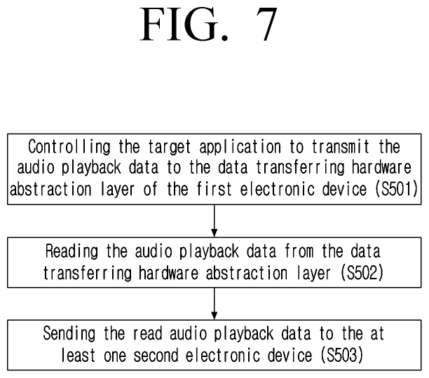

An exemplary embodiment of operation S500 is also described below in connection with FIG. 7.

FIG. 3 illustrates a flowchart of a method for providing target audio data to a target application according to an exemplary embodiment of the disclosure.

Referring to FIG. 3, in operation S401, the method may include transmitting the target audio data to a data transferring hardware abstraction layer (HAL) of the first electronic device.

Here, the data transferring or forwarding hardware abstraction layer may a Remote Submix HAL.

In operation S402, the method may include controlling the target application to read the target audio data from the data transferring hardware abstraction layer.

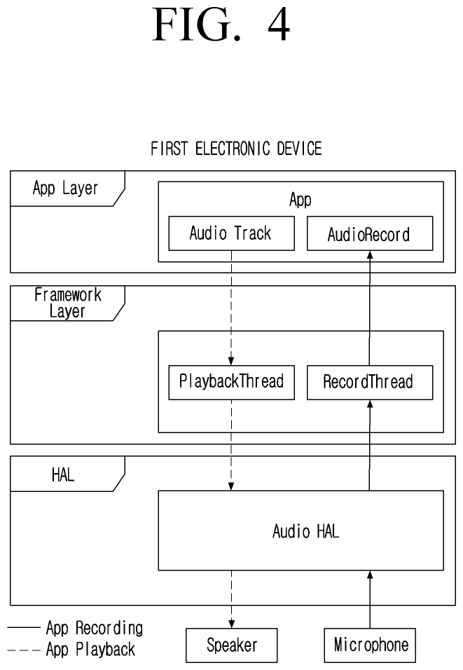

FIG. 4 illustrates an audio processing architecture diagram in which a first electronic device normally uses audio capability of the first electronic device (e.g., uses its own audio capability) according to an exemplary embodiment of the disclosure. As shown in FIG. 4, the process may include the first electronic device acquiring audio data (i.e., audio recording data) via a microphone (Mic) and transmitting the audio data to an audio hardware abstraction layer (Audio HAL), and an application (APP) of the first electronic device reading the recording data from the Audio HAL. Moreover, the process may include the application (APP) transferring audio playback data to the Audio HAL and the first electronic device reproducing or playing the audio playback data through an audio playback apparatus (e.g., a speaker).

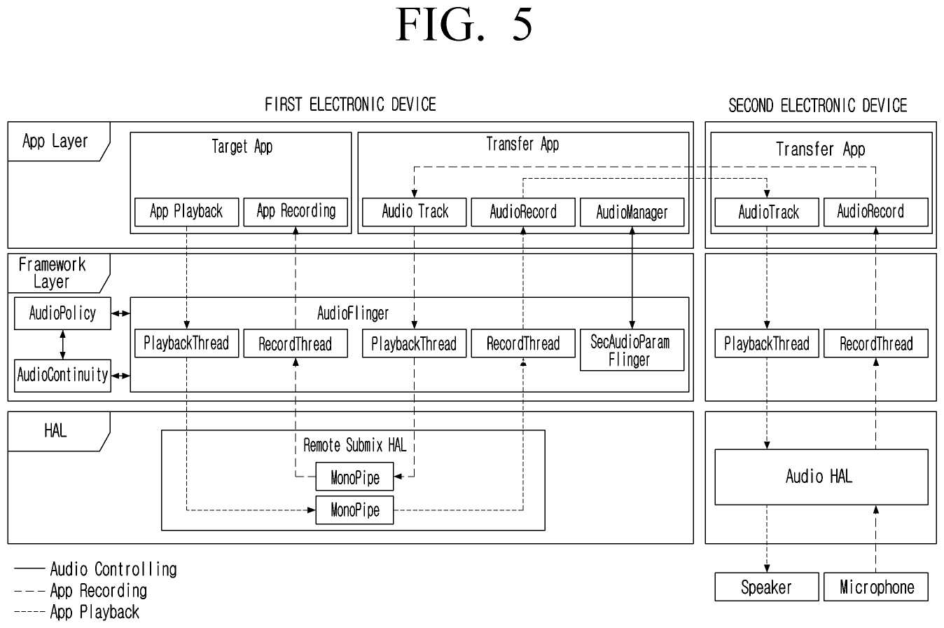

FIG. 5 illustrates an audio processing architecture diagram in which a first electronic device uses an audio capture capability of one other device (e.g., at least one second device) according to an exemplary embodiment of the disclosure. As shown in FIG. 5, the process may include a second electronic device obtaining audio data (e.g., audio recording data) via the audio capture apparatus of the second electronic device and sending the audio data to a transfer application (transfer APP) of the first electronic device via a transfer APP on the second electronic device. The transfer APP of the first electronic device may transfer the received audio recording data (i.e., target audio data) of the second electronic device to a Remote Submix HAL through an AudioTrack. In an example case in which the first electronic device identifies that the audio recording data of the target application is successfully switched to the Remote Submix HAL, the first electronic device controls a target application (a target APP) to read the target audio data from the Remote Submix HAL.

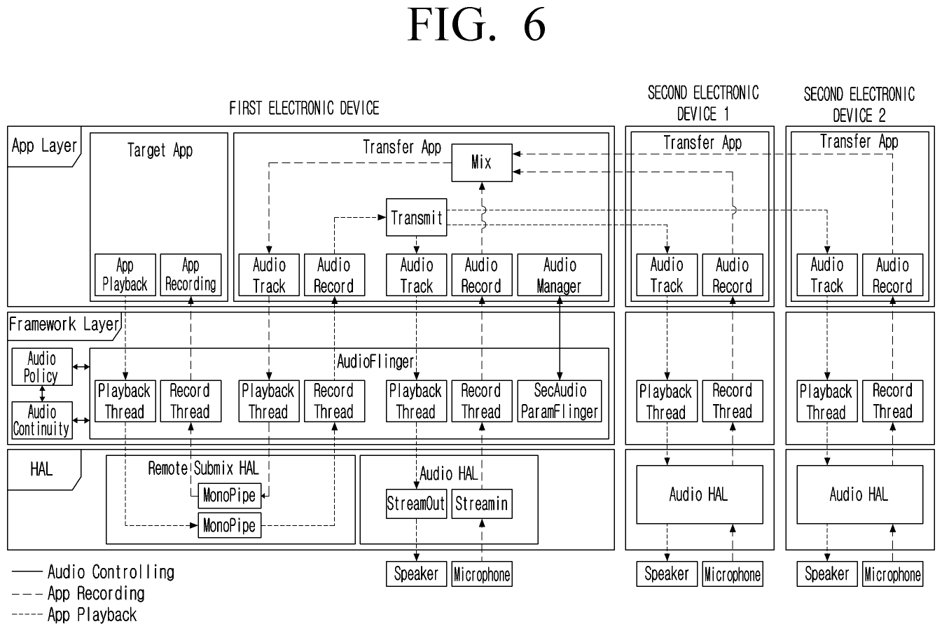

FIG. 6 illustrates an audio processing architecture diagram in which a first electronic device uses audio capture capabilities of multiple second devices according to an exemplary embodiment of the disclosure. As shown in FIG. 6, the process may include a second electronic device 1 and a second electronic device 2 obtaining audio recording data via their own respective audio capture apparatus and sending the capture audio recording data to a transfer APP of the first electronic device via their respective transfer APP. Moreover, the first electronic device may transmit audio recording data obtained via its own audio capture apparatus to an Audio HAL. The transfer APP of the first electronic device may read the audio recording data of the first electronic device from the Audio HAL via an AudioRecord, and the transfer APP of the first electronic device may mix the audio recording data of each of the second electronic devices and the audio recording data of the first electronic device to obtain target audio data. Further, the transfer APP of the first electronic device may transmit the target audio data to a Remote Submix HAL via an AudioTrack. In an example case in which the first electronic device identifies that the audio recording data of the target application is successfully switched to the Remote Submix HAL, it controls the target application to read the target audio data from the Remote Submix HAL. The AudioRecord and the AudioTrack may be understood as API interfaces.

It is worth noting that compared to FIG. 4, the target application is controlled to read audio data from the Remote Submix HAL in FIG. 5 and FIG. 6 instead of from the Audio HAL. In fact, at this time, the audio recording data transferring path between the target application and the Audio HAL is disconnected, for example, the data transferring path between the RecordThread and the Audio HAL as illustrated in FIG. 4 is disconnected.

FIG. 7 illustrates a flowchart of a method for sending audio playback data of a target application to at least one second electronic device according to an exemplary embodiment of the disclosure.

Referring to FIG. 7, in operation S501, the target application is controlled to transfer the audio playback data to a data transferring hardware abstraction layer of the first electronic device.

In operation S502, the audio playback data is read from the data transferring hardware abstraction layer.

At operation S503, the audio playback data read from the data transferring hardware abstraction layer is sent to the at least one second electronic device.

In addition, the data processing method applied to the first electronic device according to the exemplary embodiment of the disclosure may further include: transmitting the audio playback data read from the data transferring hardware abstraction layer to an audio hardware abstraction layer of the first electronic device, to play the audio playback data through an audio playback apparatus of the first electronic device.

As shown in FIG. 5, the process for the first electronic device using the audio playback capability of the one other device includes: in an example case in which the first electronic device identifies that the audio playback data of the target application is successfully switched to the Remote Submix HAL, it may read the audio playback data of the target application from the Remote Submix HAL via the AudioRecord; the transfer APP of the first electronic device sends the read audio playback data to the transfer APP of the second electronic device, and the transfer APP of the second electronic device transfers the received audio playback data to its own Audio HAL and then performs audio playback through an audio playback apparatus (e.g., a speaker).

As shown in FIG. 6, the process for the first electronic device using the audio playback capabilities of the multiple devices includes: in an example case in which the first electronic device identifies that the audio playback data of the target application is successfully switched to the Remote Submix HAL, it can read the audio playback data of the target application from the Remote Submix HAL via the AudioRecord and then copy it; the transfer APP of the first electronic device sends the copied audio playback data to the transfer APP of each second electronic device and transmits it to the Audio HAL of the first electronic device in real time.

According to an embodiment, compared to FIG. 4, the target application may be controlled to transfer the audio playback data to the Remote Submix HAL in FIGS. 5 and 6 instead of to the Audio HAL. In fact, at this time, the audio playback data transferring path between the target application and the Audio HAL is disconnected, for example, the data transferring path between the PlaybackThread and the Audio HAL as illustrated in FIG. 4 is disconnected.

In addition, the data processing method applied to the first electronic device according to the exemplary embodiment of the disclosure may further include: resuming normal use of the audio capability of the first electronic device after ending use of the audio capability of the at least one second electronic device.

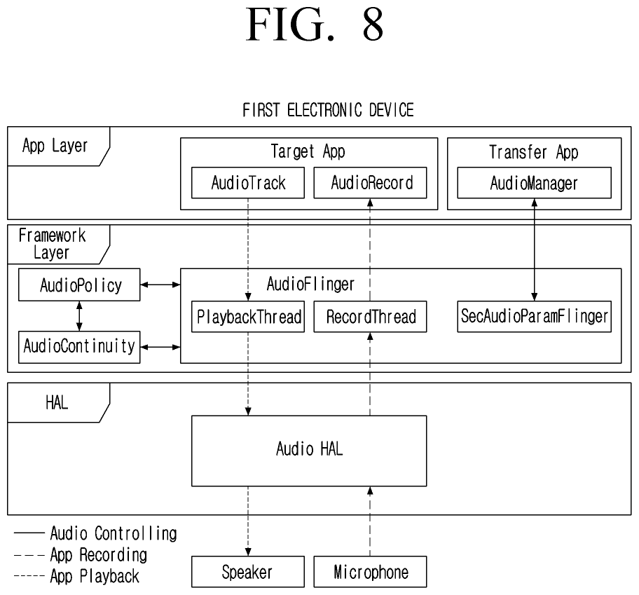

As an example, the first electronic device may pass parameters to a system to end the use of the audio capability of the at least one device, stop the transfer APP from acquiring the audio recording data/audio playback data on the first electronic device and the second electronic device, reconnect the audio playback data stream of the target application to its own audio playback apparatus via the Audio HAL, and reconnect the audio recording data stream of the target application to its own audio capture apparatus via the Audio HAL. FIG. 8 illustrates an audio processing architecture diagram after a first electronic device ends use of an audio capability of at least one second device according to an exemplary embodiment of the disclosure. It should be understood that some interfaces (e.g., AppPlayback, AppRecording, AudioRecord, AudioTrack, etc.), threads (e.g., PlaybackThread, RecordThread, etc.), modules (e.g., AudioFlinger, AudioContinuity, etc.), pipes (e.g., MonoPipe), etc., for implementing audio control, application recording, application playback are also illustrated exemplarily in FIGS. 4-6 and 8, which are not described herein.

According to the exemplary embodiments of the disclosure, an electronic device may use an audio capability of at least one other device, for example, may use audio capabilities of multiple other electronic devices, may use an audio capability of at least one other device together with its own audio capability, thereby enabling a more convenient and richer multi-device linkage experience for users.

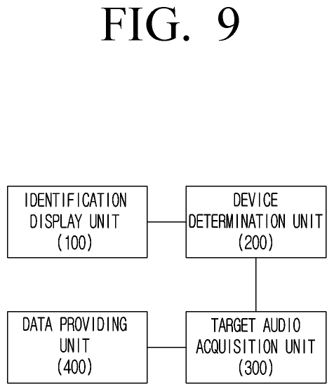

FIG. 9 illustrates a block diagram of a structure of a data processing apparatus according to an exemplary embodiment of the disclosure.

Referring to FIG. 9, the data processing apparatus according to the exemplary embodiment of the disclosure includes: an identification display unit 100, a device determination unit 200, a target audio data acquisition unit 300 and a data providing unit 400.

Specifically, the identification display unit 100 is configured to display, on an display of the first electronic device, identification information of at least one other electronic device.

The device determination unit 200 is configured to determine at least one second electronic device based on an operation of performed by the user of the identification information of the at least one other electronic device.

The target audio data acquisition unit 300 is configured to acquire audio recording data captured by an audio capture apparatus of the at least one second electronic device, and generate target audio data based on the acquired audio recording data.

The data providing unit 400 is configured to provide the target audio data to a target application.

As an example, the target audio data acquisition unit 300 is configured to: in an example case in which the number of the at least one second electronic device is one, use audio recording data captured by the audio capture apparatus of the one second electronic device as the target audio data; in an example case in which the number of the at least one second electronic device is multiple, mix audio recording data captured by the audio capture apparatuses of the multiple second electronic devices to obtain the target audio data; or mix audio recording data captured by the audio capture apparatuses of the at least one second electronic device and the first electronic device to obtain the target audio data.

As an example, the data providing unit 400 is configured to: transmit the target audio data to a data transferring hardware abstraction layer of the first electronic device; control the target application to read the target audio data from the data transferring hardware abstraction layer.

As an example, the data processing apparatus according to the exemplary embodiment of the disclosure may further include a data sending unit, the data sending unit is configured to send audio playback data of the target application to the at least one second electronic device, and trigger an audio playback apparatus of the at least one second electronic device to play the audio playback data.

As an example, the data sending unit is configured to: control the target application to transmit the audio playback data to the data transferring hardware abstraction layer of the first electronic device; read the audio playback data from the data transferring hardware abstraction layer; send the read audio playback data to the at least one second electronic device.

As an example, the data processing apparatus according to the exemplary embodiment of the disclosure may further include a data transmission unit. According to an embodiment, the data transmission unit may be configured to transmit the read audio playback data to an audio hardware abstraction layer of the first electronic device to play the audio playback data through an audio playback apparatus of the first electronic device.

As an example, the data processing apparatus according to the exemplary embodiment of the disclosure may further include a data processing unit. According to an embodiment, the data processing unit may be configured to send the target audio data outwardly via the target application, and/or, save the target audio data in the first electronic device via the target application.

As an example, the data processing apparatus according to the exemplary embodiment of the disclosure may further include a connection establishment unit. According to an embodiment, the connection establishment unit may be configured to establish a communication connection with the at least one second electronic device, or establish a communication connection with the at least one other electronic device; wherein the target audio data acquisition unit is configured to: acquire, via the communication connection, the audio recording data captured by the audio capture apparatus of the at least one second electronic device.

It should be understood that the specific processing performed by the data processing apparatus according to the exemplary embodiment of the disclosure has been described in detail with reference to FIGS. 1 through 8, and the relevant details will not be repeated here.

Furthermore, according to the exemplary embodiment of the disclosure, units or modules in the data processing apparatus illustrated in FIG. 9 may be implemented as hardware components and/or software components. According to an embodiment, use a field programmable gate array (FPGA) or an application specific integrated circuit (ASIC) may be used to implement the individual units or modules, depending on the processing performed by the individual units or modules as defined. However, the disclosure is not limited thereto, and as such, the units and/or modules of the disclosure may be implemented as software codes, computer programs and/or instructions which may be stored on a memory, and at least one processor may be configured to executed the software codes, computer programs and/or instructions in the memory to perform the methods and operations of the disclosure. According to an embodiment, two or more of the units illustrated in FIG. 9 combined into a single unit. According to another embodiment, an unit may illustrated in FIG. 9 maybe divided combined into multiple units.

A computer readable storage medium according to an exemplary embodiment of the disclosure stores a computer program that, when executed by a processor, causes the processor to perform a data processing method as described in the above exemplary embodiments. The computer readable storage medium may be any data storage apparatus that can store data read by a computer system. Examples of the computer readable storage media may include: a read-only memory, a random access memory, a read only CD-ROM, a magnetic tape, a floppy disk, an optical data storage apparatus, and a carrier wave (such as data transmission over an Internet via a wired or wireless transmission path).

The electronic device according to the exemplary embodiments of the disclosure includes: a processor and a memory, wherein the memory stores a computer program that, when executed by the processor, implements a data processing method as described in the above exemplary embodiments.

While some exemplary embodiments of the disclosure have been represented and described, it should be understood by those skilled in the art that these embodiments may be modified without departing from the principles and spirit of the disclosure as limited in scope by the claims and their equivalents.

What is claimed is:

1. A method performed by a first electronic device, the method comprising:
displaying, on a display of a first electronic device, identification information of one or more candidate electronic devices;
determining at least one second electronic device, from among the one or more candidate electronic devices, based on a selection by a user;
acquiring audio data captured by the at least one second electronic device;
generating target audio data based on the acquired audio data; and
providing the target audio data to a target application.

2. The method according to claim 1, wherein the generating of the target audio data based on the acquired audio data comprises:
based on a number of the at least one second electronic device being one, using the audio data captured by the at least one second electronic device as the target audio data;
based on the number of the at least one second electronic device being more than one, mixing first audio data captured by a first second electronic device and second audio data captured by a second second electronic device to obtain the target audio data, the acquired audio data comprising the first audio data and the second audio data; or
mixing the audio data captured by the at least one second electronic device and third audio data captured by the first electronic device to obtain the target audio data.

3. The method according to claim 1, wherein the providing of the target audio data to the target application comprises:
transmitting the target audio data to a data transferring hardware abstraction layer of the first electronic device; and
controlling the target application to read the target audio data from the data transferring hardware abstraction layer.

4. The method according to claim 1, wherein after determining the at least one second electronic device, the method further comprises:
sending audio playback data of the target application to the at least one second electronic device, and
controlling an audio playback apparatus of the at least one second electronic device to play the audio playback data.

5. The method according to claim 4, wherein the sending of the audio playback data of the target application to the at least one second electronic device comprises:
controlling the target application to transmit the audio playback data to a data transferring hardware abstraction layer of the first electronic device;
reading the audio playback data from the data transferring hardware abstraction layer; and
sending the read audio playback data to the at least one second electronic device.

6. The method according to claim 5, further comprising:
transmitting the read audio playback data to an audio hardware abstraction layer of the first electronic device to play the audio playback data through an audio playback apparatus of the first electronic device.

7. The method according to claim 1, wherein after providing the target audio data to the target application, the data processing method further comprises:
sending the target audio data external to the first electronic device via the target application, or
saving the target audio data in the first electronic device via the target application.

8. The method according to claim 1, further comprising:
establishing a communication connection with the at least one second electronic device, or establishing a communication connection with the one or more candidate electronic devices, and
wherein the acquiring of the audio data captured by the at least one second electronic device comprises:
acquiring, via the communication connection, the audio data captured by the at least one second electronic device.

9. An apparatus comprising:
a memory configured to store instructions, and
at least one processor configured to execute the instructions to:
display, on a display of a first electronic device, identification information of one or more candidate electronic devices;
determine at least one second electronic device, from among the one or more candidate electronic devices, based on a selection by a user;
acquire audio data captured by the at least one second electronic device;
generate target audio data based on the acquired audio data; and
provide the target audio data to a target application.

10. A computer readable storage medium having a computer program stored thereon, wherein the computer program, when executed by a processor, implements a data method comprising:
displaying, on a display of a first electronic device, identification information of one or more candidate electronic devices;
determining at least one second electronic device, from among the one or more candidate electronic devices, based on a selection by a user;
acquiring audio data captured by the at least one second electronic device;
generating target audio data based on the acquired audio data; and
providing the target audio data to a target application.

11. An electronic device comprising:
a memory configured to store instructions, and
at least one processor configured to execute the instructions to:
display a list including one or more candidate electronic devices;
determine at least one second electronic device, from among the one or more candidate electronic devices, based on a selection by a user;
establish communication with the at least one second electronic device;
acquire data obtained by a component of the at least one second electronic device;
generate target data based on the acquired data; and
output the target data
